(19) United States
(12) Patent Application Publication
(10) Pub. No.: US 2017/0245243 A1
(43) Pub. Date: Aug. 24, 2017

(54) D2D Operation with Adapted Receiver

(71) Applicant: TELEFONAKTIEBOLAGET LM ERICSSON (PUBL), Stockholm (SE)

(72) Inventors: Iana Siomina, Täby (SE); Muhammad Kazmi, Sundbyberg (SE)

(21) Appl. No.: 15/504,065

(22) PCT Filed: Aug. 11, 2015
(86) PCT No.: PCT/SE2015/050866

§ 371 Date: Feb. 15, 2017

Related U.S. Application Data
(60) Provisional application No. 62/038,519, filed on Aug. 18, 2014.

(51) Int. Cl. H04W 72/02; H04W 76/02; H04W 72/04

(52) U.S. Cl. CPC H04W 72/02; H04W 72/0453; H04W 76/023

(57) ABSTRACT

There is disclosed a D2D enabled node (10) for a wireless communication network, the D2D enabled node (10) comprising a receiver. The D2D enabled node (10) further is adapted for adapting a receiver configuration to receive signals simultaneously on a first carrier frequency f1 and a second carrier frequency f2. There are also disclosed related devices and methods.

### TECHNICAL FIELD

This disclosure generally pertains to device-to-device communication techniques in the context of wireless and/or cellular communication networks.

### BACKGROUND

If D2D enabled nodes or UEs are in proximity to each other, they may be able to use a “direct mode” (e.g., as in FIG. 1) or “locally-routed” (e.g., as in FIG. 2) path for data communication, unlike in the conventional cellular communication (FIG. 3). In such device-to-device communication (D2D), which may also be called “ProSe” (for PROximity SErvices), the source and the target are wireless devices like D2D enabled nodes, e.g., UEs. Some of the potential advantages of D2D or ProSe are off-loading of the cellular network, faster communication, increased awareness of surrounding wireless devices of interest (e.g., running the same application), higher-quality links due to a shorter distance, etc. Some appealing applications of D2D communications are video streaming, online gaming, media downloading, peer-to-peer (P2P), file sharing, etc.

Including D2D communication functionality into cellular-based technology brings a variety of new challenges, e.g. in terms of receiver utilization of D2D enabled nodes.

### SUMMARY

D2D operation in particular in the context of multiple carriers and/or parallel cellular operation can require significant resources, in particular regarding receiver circuitry. An object of the present disclosure is to provide approaches allowing improved use of receiver circuitry of a D2D enabled node for D2D operation.

There is disclosed a D2D enabled node for a wireless communication network, the D2D enabled node comprising a receiver, the D2D enabled node further being adapted for adapting a receiver configuration to receive signals simultaneously on a first carrier frequency f1 and a second carrier frequency f2. Thus, the receiver may be used for receiving on two carrier frequencies. No additional receiver is required for this functionality, saving hardware and correspondingly lowering costs and required space.

The receiver may be adapted for a receive operation comprising receiving, on at least the first carrier frequency f1, in a D2D receive operation, and receiving, on at least the second carrier frequency f2, in a D2D receive operation or a cellular receive operation. The receiver hence may be used in a combination of receive operation comprising at least a D2D receive operation.

There is also disclosed a method performed by a D2D enabled node, the D2D enabled node comprising a receiver. The method comprises adapting a receiver configuration to receive signals simultaneously on a first carrier frequency f1 and a second carrier frequency f2.

It may be considered that the method further comprising receiving, on at least the first carrier frequency f1, in a D2D receive operation, and receiving, on at least the second carrier frequency f2, in a D2D receive operation or a cellular receive operation.

A network node for a wireless communication network is proposed. The network node is adapted for obtaining an indication of at least one D2D enabled node regarding the D2D enabled node's ability to configure its receiver bandwidth to simultaneously receive signals over multiple carrier frequencies. The network node further is adapted for using the indication for one or more operational tasks. Thus, the network node may e.g. control the D2D operation and/or receiver bandwidth of the D2D enabled node, allowing more efficient use of available capabilities and/or resources.

In addition, there is disclosed a method performed by a network node, the method comprising obtaining an indication of at least one D2D enabled node regarding the D2D enabled node's ability to configure its receiver bandwidth to simultaneously receive signals over multiple carrier frequencies. The method further comprises using the indication for one or more operational tasks.

A computer program product comprising instructions executable by control circuitry is considered. The instructions cause the control circuitry to carry out and/or control any one of the methods described herein when executed by the control circuitry.

Moreover, a storage medium adapted to store instructions executable by control circuitry is disclosed. The instructions cause the control circuitry to carry out and/or control any one of the methods disclosed herein when executed by the control circuitry.

### BRIEF DESCRIPTION OF THE DRAWINGS

In the figures, there are shown examples of devices and methods related for illustrative purposes. In particular, there are shown in:

FIG. 1 a “Direct mode” data path in the EPS for communication between two UEs;

FIG. 2 a “Locally-routed” data path in the EPS for communication between two UEs when UEs are served by the same eNBs;

FIG. 3 a default data path scenario in the EPS for cellular communication between two UEs;

FIG. 4 an exemplary D2D architecture;

FIG. 5 an exemplary D2D enabled node or UE; and

FIG. 6 an exemplary network node.

### DETAILED DESCRIPTION

Generally, a UE may be considered as an example or representative of a D2D enabled node, and the term D2D enabled node may be interchanged for UE unless explicitly stated otherwise. An eNB or base station may be considered to be one variant of a network node.

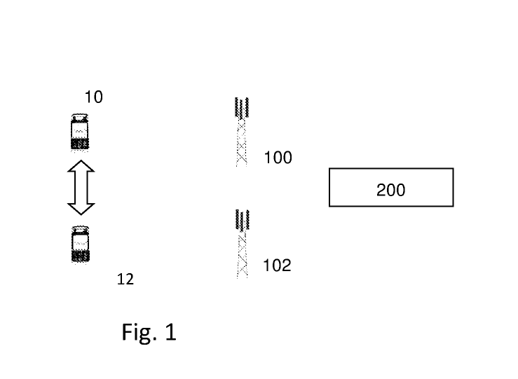

In FIGS. 1 to 3, there are shown different setups for communication of user equipments within a wireless communication network. In these figures, the first node or first user equipment UE1 is indicated with reference numeral 10, the second node or second user equipment is indicated with reference numeral 12. A first base station or network node, which may be an eNodeB and/or EPC according to LTE/E-UTRAN, carries the reference numeral 100, whereas a second base station, which may be an eNodeB and/or EPC according to LTE/UTRAN, is referenced with numeral 102.

The nodes 100, 102 may be configured as coordinating nodes for D2D communication between the UEs 10, 12. Reference numeral 200 indicates higher layer functions or devices of the network, to which the base stations 100, 102 may be connected or connectable, e.g. LTE packet core elements like SGW (Server GateWay) and/or PGW (PDN GateWay) and/or MME (Mobility Management Entity).

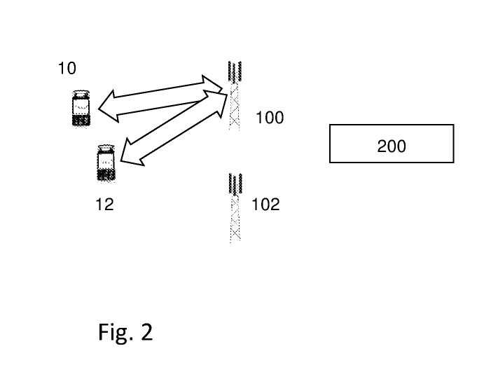

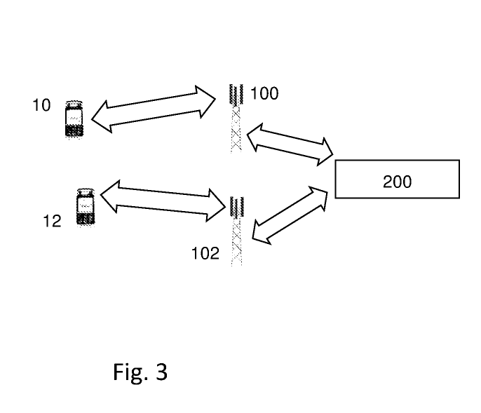

If UEs 10, 12 are in proximity to each other, they may be able to use a “direct mode” (e.g., as in FIG. 1) or “locally-routed” (e.g., as in FIG. 2) path for data communication, unlike in the conventional cellular communication (FIG. 3).

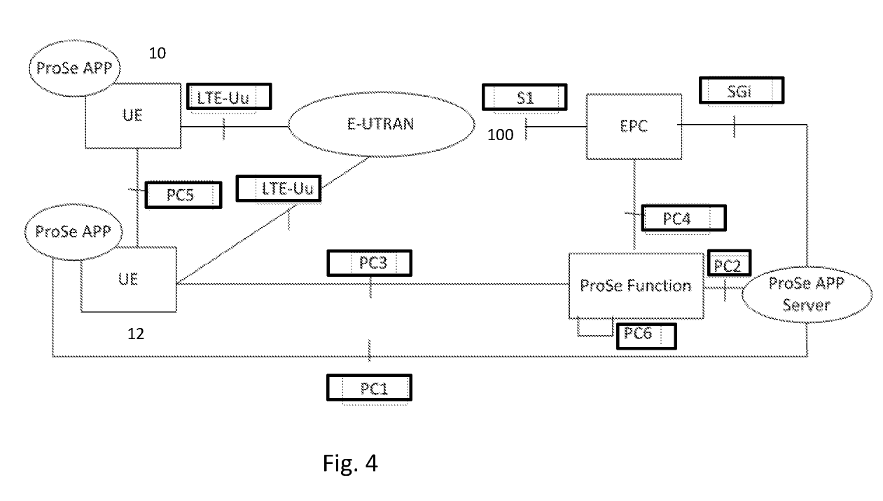

A more detailed example reference architecture for D2D operation according to one possible LTE/E-UTRAN implementation is illustrated in FIG. 4, in which only a setup with two UEs 10, 12 connected to a common base station or eNodeB 100 is shown. In FIG. 4, PCn identifies different reference points or interfaces. PC1 refers to a reference point between a ProSe application ProSe APP running on a D2D enabled node or UE 10 or 12, PC2 a reference point between an ProSe Application server and a ProSe function provider on a server or base station side. PC3 indicates a reference point between the D2D enabled node or UE 12 and the ProSE function, e.g. for discovery and/or communication. PC4 refers to a reference point between the EPC and the ProSe function, e.g. for setting up setting up one-to-one communication between UEs 10 and 12. PC5 is a reference point between D2D enabled node or UE 10 and D2D enabled node or UE 12, e.g. a first node and a second node involved in D2D communication, which may be used e.g. for direct or relayed communication between the UEs. PC6 identifies a reference point between ProSE functions of different networks, e.g. if UEs 10, 12 are subscribed to different PLMNs (Public Land Mobile Networks).

SGi indicates an interface which may be used, inter alia, for application data and/or application level control. The EPC (Evolved Packet Core) may generally include a plurality of core packet functions or entities, e.g. MME, SGW, PWG, PCRF (Policy Charging and Rules Function), HSS (Home Subscriber Server), etc. E-UTRAN is the preferred RAT of the arrangement of FIG. 4. LTE-Uu indicates data transmission connections between the UEs 10, 12 and the base station 100.

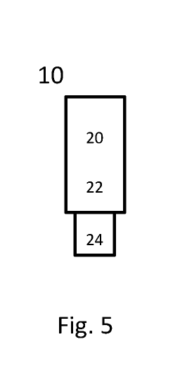

FIG. 5 schematically shows a D2D enabled node 10, which may be implemented in this example as a user equipment, which may be a node of a device-to-device communication, in closer details. User equipment 10 comprises control circuitry 20, which may comprise a controller connected to a memory. A D2D device and/or any modules of a D2D device, e.g. a receiving module and/or transmission module and/or control module, may be implemented in and/or executable by, the control circuitry 20, in particular as module in the controller. The user equipment also comprises radio circuitry 22 providing receiving and transmitting or transceiving functionality, the radio circuitry 22 connected or connectable to the control circuitry. An antenna circuitry 24 of the user equipment 10 is connected or connectable to the radio circuitry 22 to collect or send and/or amplify signals. Radio circuitry 22 and the control circuitry 20 controlling it are configured for device-to-device communication, in particular utilizing E-UTRAN/LTE resources as described herein and/or receiving allocation data and/or transmit D2D data based on allocation data.

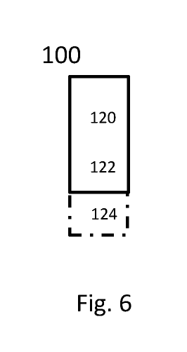

FIG. 6 schematically show a base station 100, which in particular may be an eNodeB as an example of a network node. Base station 100 comprises control circuitry 120, which may comprise a controller connected to a memory. A configuring unit and/or a determination unit or corresponding module may be comprised in the control circuitry, the latter in particular if the base station is configured as a coordinating node.

The control circuitry is connected to control radio circuitry 122 of the base station 100, which provides receiver and transmitter and/or transceiver functionality. It may be considered that control circuitry 120 comprises an extracting unit as described herein, in particular if the base station is configured to participate as a device in D2D communication. An antenna circuitry 124 may be connected or connectable to radio circuitry 122 to provide good signal reception or transmittance and/or amplification. The base station 100 may be seen as an example of a network node. A network device and/or any module/s of a network device may be implemented on the network node, in particular the control circuitry of the network node may be adapted to execute the network device.

Each or any one of the user equipments shown in the figures may be adapted to perform the methods to be carried out by a user equipment or D2D enabled node described herein. Alternatively or additionally, each or any of the user equipments shown in the figures may comprise any one or any combination of the features of a user equipment or D2D enabled node described herein.

Each or any one of the network nodes or eNBs or base stations shown in the figures may be adapted to perform the methods to be carried out by network node or base station described herein. Alternatively or additionally, the each or any one of the network nodes or eNBs or base stations shown in the figures may comprise any one or any one combination of the features of a network node or eNB or base station described herein.

In systems with multiple carrier frequencies, a D2D enabled node or UE may operate over two or more carrier frequencies in parallel or in a sequential order, e.g., when performing measurements, transmitting or receiving radio signals or channels. Simultaneous or parallel operation over two or more carrier frequencies generally may require a higher complexity in the D2D enabled node or UE and a more complex receiver structure than operation in sequential order.

Inter-frequency operation generally may refer to operating, e.g. performing measurements (e.g., inter-frequency RSRP/RSRQ and RSTD) and/or receiving broadcast channels (e.g., system information reading on PBCH), on a carrier frequency which is different from the serving frequency(-ies).

A D2D enabled node or UEs with a single receiver chain normally require measurement gaps for inter-frequency operation; other D2D enabled node or UEs may be always or in certain conditions capable of inter-frequency operation without measurement gaps.

The difference of CA (carrier aggregation) to inter-frequency operation is that in carrier aggregation, the D2D enabled node or UE has a possibility of operating over multiple serving cells or on a serving cell(s) which are not the primary serving cell. In such multi-carrier or carrier aggregation cellular system, a carrier is generally termed as a component carrier (CC) or sometimes is also referred to as cell or serving cell. In principle each CC has multiple cells. The term carrier aggregation (CA) is also called (e.g. interchangeably called) “multi-carrier system”, “multi-cell operation”, “multi-carrier operation”, “multi-carrier” transmission and/or reception.

This means that CA may be used for transmission of signaling and data in the uplink and/or downlink directions. One of the CCs is the primary component carrier (PCC), which may also be referred to as simply primary carrier or anchor carrier and which may define or correspond to a primary cell (PCell). The remaining CCs are called secondary component carrier (SCC) or simply secondary carriers or even supplementary carriers and may define or correspond to one or more secondary cells or serving cells (SCell).

Generally, the primary or anchor CC may carry the essential D2D enabled node or UE specific signaling and/or control data. A primary CC (aka PCC or PCell) may exists in both uplink and downlink directions in CA. In case there is single UL CC, the PCell may be on that CC. The network may assign different primary carriers to different D2D enabled nodes or UEs operating in the same sector or cell. Generally, the term cell may refer to a PCell or a SCell.

It may be assumed that a D2D enabled node or UE both is adapted to transmit and receive in the uplink spectrum of a frequency band (for D2D).

To support both transmit and receive operations in the same band, the D2D enabled node or UE needs to implement both its transmitter and its receiver compliant to existing transmitter and receiver requirements, respectively, for this band.

Generally, a D2D enabled node or UE using its or one of its receiver/s for operating D2D on one carrier frequency, may be not able to receive signals or channels for D2D or for cellular DL operation on another carrier frequency, in particular using this receiver/these receivers. In particular, it may be the case that the D2D enabled node or UE cannot receive in cellular DL while using the only rx (receiver) for D2D (e.g., if the D2D enabled node only has one receiver).

A D2D enabled node or UE generally may be adapted to configure its receiver bandwidth to receive signals over multiple carrier frequencies and/or bands. In particular, the D2D enabled node or UE may be adapted to configure and/or tune its receiver to receive signals on at least one of multiple carrier frequencies and/or bands at a time; the receiver may be configurable and/or tunable to receive any one or any combination of at least two of the multiple carrier frequencies and/or bands, e.g. individually, such that for example the receiver may be configured and/or tuned to receive on any specific carrier frequencies or band and/or any combination of at least two of the multiple carrier frequencies or bands.

It may be considered that the receiver is not adapted to receive on every possible combination of individual carries it is enabled to receive, but that a receiver is generally adapted to be able to receive a given set of combinations of carriers, which may be out of a larger set of (individual) carriers.

Radio circuitry, to which the receiver may belong, of the D2D enabled node or UE may be adapted to perform such configuring and/or tuning, e.g. controlled by control circuitry of the D2 enabled node or UE. Control circuitry of the D2D enabled node or UE may be adapted to control such configuring and/or tuning. The configuration of a receiver may refer and/or comprise the carrier frequency/ies or band/s it is configured and/or tuned to receive and/or a time distribution or schedule of carrier frequency/ies or band/s it is configured and/or tuned to receive.

A carrier may generally indicate a carrier frequency and/or band, which may be a specific part of a radio spectrum and may be defined by a given standard, e.g. LTE.

There are for example described steps or methods, in and/or performed by, a D2D enabled node or UE. The methods may comprise any one or any combination of the following steps. A D2D enabled node may be adapted to carry out and/or perform any of the methods and/or any one or any combination of the steps. There may be envisioned a D2D device for performing any one or any combination of the steps or the method, wherein the D2D device may comprise corresponding modules; a module may be for performing one or more than one of these steps:

Step 0 (Optional): Indicating to another node the D2D enabled node or UE's ability to configure its receiver bandwidth to receive signals over multiple carrier frequencies, in particular indicating capability information, which may comprise corresponding information regarding the ability to configure its receiver bandwidth. The D2D enabled node or UE may generally be adapted to determine its receiver bandwidth, e.g. by testing the receiver and/or by reading corresponding information from a memory, in particular from a non-volatile memory or register. A D2D device may comprise a D2D indicating module adapted for performing indicating and/or determining as described regarding step 0.

Step 1 (Optional): Determining the need to
Receive first signals for performing D2D receive operation on at least one first carrier frequency f1, and
Receive second signals for performing D2D receive operation and/or cellular receive operation on at least one second carrier frequency f2. Determining the need may be based on signals and/or requests from another D2D enabled node and/or a network node and/or user input and/or operation conditions (e.g., D2D communication may be needed in an emergency situation, which may be indicated by a signal from an external source). A D2D device may comprise a D2D need determining module for determining the need as described in step 1.

Step 2 (Optional): Determining and/or configuring resources R1 and R2 on f1 and f2, respectively (may be pre-defined or configurable by the D2D enabled node or UE autonomously or by the network node). Determining and/or configuring resources may be based upon allocation data, which may be received from a network node, in particular an allocation or coordinating node and/or base station like an eNodeB. Determining and/or configuring resources may comprise receiving allocation data, in particular from such a network node. A D2D device may comprise a D2D resource determining module for determining and/or configuring resources as described in step 2.

Step 3: Adapting the receiver configuration to receive signals simultaneously on f1 and f2, wherein adapting the receiver comprises configuring at least the receive bandwidth over f1 and f2 for simultaneous receiving of signals on f1 and f2. f1 and f2 may refer to different carrier frequencies and/or bands. Adapting may comprise configuring and/or tuning the receiver to receive a bandwidth and/or frequencies and/or a frequency range including and/or covering at least f1 and f2 and/or two different carriers. Additionally or alternatively, adapting may comprise configuring and/or tuning the receiver to expand its bandwidth from a first bandwidth covering a first carrier and/or carrier frequency or band (e.g. f1 or f2, and/or B1 or B2) to a second bandwidth covering the first carrier and/or carrier frequency or band (e.g. f1 or f2, and/or B1 or B2), as well as a second carrier and/or carrier frequency or band different from the first (e.g. f2 or f1, and/or B2 or B1, respectively), in particular to cover f1+f2 and/or B1+B2. A D2D device may comprise a D2D adaption module for adapting the receiver configuration as described in step 3.

Step 4 (optional): Receiving, in particular receiving simultaneously, using the adapted receiver configuration. This receiving may comprise receiving at least one of the first signals and/or receiving, e.g. signals, on the first carrier and/or carrier frequency and/or band (and/or f1), and receiving, at least one of the second signals and/or receiving, e.g. signals, on the second carrier and/or carrier frequency and/or band (and/or f2). It may be considered that this receiving (in particular receiving simultaneously) refers to using one receiver to receive on different carriers (e.g., carrier frequencies and/or bands) within a given timescale or time unit, e.g. subframe or frame (for example, subframe or frame according to LTE). The receiver may be adapted to switch, in particular within the given timescale or time unit, between such carriers according to its configuration and/or controlled by control circuitry of the D2D enabled node or UE, and/or to share the receiver and/or use of the receiver between different carrier frequencies. Alternatively or additionally, receiving simultaneously, in particular by one receiver using the adapted receiver configuration, may comprise receiving, in particular at the same time and/or in the same time resource (e.g. slot or subframe, for example in LTE), on both carriers and/or on f1 and f2 and/or on a frequency range or bandwidth covering and/or including at least f1 and f2.

Alternatively or additionally, there are described steps or methods, in and/or performed by, a network node. The methods may comprise any one or any combination of the following steps. A network node may be adapted to carry out and/or perform any of the methods and/or any one or any combination of the steps. There may be envisioned a network device for performing any one or any combination of the steps or the methods, wherein the network device may comprise corresponding modules; a module may be for performing one or more than one of these steps:

Step N1: Obtaining an indication, which may be an ability indication and/or may comprise capability information, of at least one D2D enabled node or UE regarding the D2D enabled node or UE's ability to configure its receiver bandwidth to simultaneously receive signals over multiple carrier frequencies. A network node may comprise a NW obtaining module for obtaining according to step N1.

Step N2: Using the D2D enabled node or UE's ability indication for one or more operational tasks. A network device may comprise a NW use module for using the ability indication as described in step N2. Operational tasks may be tasks as described below.

The approaches describes herein provide the possibility of simultaneous reception of signals and/or channels on two or more carrier frequencies with a single receiver, where at least one (first) carrier frequency is used for D2D operation and at least one (second) carrier frequency is used for D2D operation or cellular DL operation.

A D2D device may comprise a D2D indicating module, e.g. for indicating capabilities information, e.g. as described herein. Additionally or alternatively, a D2D device may comprise a capabilities information transmitting device for transmitting a capabilities indication or indication message as described herein.

Cellular DL operation of a D2D enabled node or UE may refer to receiving transmissions in DL, in particular in cellular operation and/or from a network node/eNB/base station. Cellular UL operation of a D2D enabled node or UE may refer to UL transmissions, in particular in cellular operation, e.g. transmitting to a network node/eNB/base station.

Indicating an information and/or condition, in particular indicating by a first node to a second node, may comprise transmitting the information, a corresponding message and/or data and/or indication, in particular from the first node to the second node, e.g. via a cellular transmission or a D2D transmission, or if the first node and second node are connected by cable, via cable. The nodes may be nodes of a wireless communication network and/or comprise at least on D2D enabled node and a network node, in particular an allocating and/or controlling and/or coordinating and/or serving node, in particular for and/or of the D2D enabled node.

Some non-limiting example scenarios in which the embodiments described in the current disclosure apply are described below. The nodes described generally may be embodiments of the D2D enabled node or UE or network node described above, respectively. The methods and devices or device modules correspond to the respective methods and devices or device modules described above. R1 and R2 generally may refer to time-frequency resources.

In some variants, a D2D enabled node or UE may be adapted to and/or be required to and/or determine to receive signals and/or channels (the term ‘signal’ may generally indicate or refer to a radio signal or a channel) on multiple carrier frequencies, wherein
The multiple carrier frequencies are comprising at least two different carrier frequencies/bands (f1 in frequency band B1 and f2 in frequency band B2, respectively) and the signals are received on resources R1 on f1 and on resources R2 on f2, and
f1 is a carrier frequency used for D2D receive operation (aka D2D signal reception operation or D2D signal receiving operation) at least in resources R1, and
f2 is a carrier frequency used for D2D receive operation and/or cellular receive operation (aka cellular signal reception operation or cellular signal receiving operation or even DL cellular signal reception operation) at least in resources R2, and
the relation between R1 and R2 may be, e.g., any one or more of:
R1 and R2 overlap, at least partly, in time,
R1 and R2 are synchronized within a threshold1 if B1=B2 and within a threshold2 if B1 is different from B2 (threshold1 may or may not be the same as threshold2),
R1 and R2 overlap in time in certain time resource (e.g. a few subframes per frame) or the amount of overlap is above a certain a threshold (e.g., at least N=1, 2, . . . subframes per radio frame), and are synchronized as above.
Transmissions on f1 and f2 may or may not be time-synchronized, e.g., radio frame numbering and/or subframe numbering may be different on f1 and f2 and they may or may not be time-aligned, and
The following RF scenarios may occur:
B1=B2 (same band),
B1 is different from B2.

A few more specific examples of RF scenarios below:
Example 1: B1=B2 is an FDD band and f1 is UL carrier frequency and f2 is DL carrier frequency,
Example 2: f1 is UL carrier frequency, f2 is UL carrier frequency,
Example 3: f1 is DL carrier frequency (as opposed to D2D operating in the (cellular) UL spectrum this variant is suggested as an alternative), f2 is DL carrier frequency (e.g. for D2D or cellular),
Example 4: R1 are UL resources, R2 are DL resources, the band is not limited to any specific duplex mode (e.g., can be FDD, TDD, HD-FDD, or other, etc.),
Example 5: R1 are UL resources, R2 are UL resources, the band is not limited to any specific duplex mode (e.g., can be FDD, TDD, HD-FDD, or other, etc.),
Example 6: R1 are DL resources, R2 are DL resources, the band is not limited to any specific duplex mode (e.g., can be FDD, TDD, HD-FDD, or other, etc.).

The frequencies f1 and f2 can be expressed as absolute frequency (e.g. in X MHz or Y GHz). The f1 and f2 may also be expressed as channel numbers aka Absolute Radio Frequency Channel Number (ARFCN) or E-UTRA Absolute Radio Frequency Channel Number (EARFCN). The carrier frequencies within frequency band are typically enumerated with unique numbers. The enumeration may be standardized such that the combination of the frequency band and the carrier frequency can be determined by a unique number called absolute radio frequency number (ARFNC). The channel numbers (e.g. EARFCN) for each band are unique to distinguish between different bands.

The embodiments described herein focus on two carrier frequencies. However, they may be adapted also for scenarios with three or more carrier frequencies where the D2D enabled node or UE needs and/or determines to receive some signals/channels on more than two carriers, in particular carrier frequencies.

The D2D enabled node or UE may or may not have other receivers or receiver chains. In case the D2D enabled node or UE has at least one other receiver, it is assumed herein that it is not used and/or cannot be used on f1 and f2 for D2D operation and cellular DL operation, respectively, e.g., because it is reserved for other purposes or cannot be used or not available in the resources R1 and R2.

There are for example described steps or methods, in and/or performed by, a D2D enabled node or UE. The methods may comprise any one or any combination of the following steps. A D2D enabled node may be adapted to carry out and/or perform any of the methods and/or any one or any combination of the steps. There may be envisioned a D2D device for performing any one or any combination of the steps or the method, wherein the D2D device may comprise corresponding modules; a module may be for performing one or more than one of these steps:

Step 0 (Optional): Indicating to another node the D2D enabled node or UE's ability to configure its receiver bandwidth to receive signals over multiple carrier frequencies, in particular indicating capability information, which may comprise corresponding information regarding the ability to configure its receiver bandwidth. The D2D enabled node or UE may generally be adapted to determine its receiver bandwidth, e.g. by testing the receiver and/or by reading corresponding information from a memory, in particular from a non-volatile memory or register. A D2D device may comprise a D2D indicating module adapted for performing indicating and/or determining as described regarding step 0.

Step 1 (Optional): Determining the need to
Receive first signals for performing D2D receive operation on at least one first carrier frequency f1, and
Receive second signals for performing a D2D receive operation and/or cellular receive operation on at least one second carrier frequency f2. Determining the need may be based on signals and/or requests from another D2D enabled node and/or a network node and/or user input and/or operation conditions (e.g., D2D communication may be needed in an emergency situation, which may be indicated by a signal from an external source). A D2D device may comprise a D2D need determining module for determining the need as described in step 1.

Step 2 (Optional): Determining and/or configuring resources R1 and R2 on f1 and f2, respectively (may be pre-defined or configurable by the D2D enabled node or UE autonomously or by the network node). Determining and/or configuring resources may be based upon allocation data, which may be received from a network node, in particular an allocation or coordinating node and/or base station like an eNodeB. Determining and/or configuring resources may comprise receiving allocation data, in particular from such a network node. A D2D device may comprise a D2D resource determining module for determining and/or configuring resources as described in step 2.

Step 3: Adapting the receiver configuration to receive signals simultaneously on f1 and f2, wherein adapting the receiver comprises configuring at least the receive bandwidth over f1 and f2 for simultaneous receiving of signals on f1 and f2. f1 and f2 may refer to different carrier frequencies and/or bands. Adapting may comprise configuring and/or tuning the receiver to receive a bandwidth and/or frequencies and/or a frequency range including and/or covering at least f1 and f2 and/or two different carriers. Additionally or alternatively, adapting may comprise configuring and/or tuning the receiver to expand its bandwidth from a first bandwidth covering a first carrier and/or carrier frequency or band (e.g. f1 or f2, and/or B1 or B2) to a second bandwidth covering the first carrier and/or carrier frequency or band (e.g. f1 or f2, and/or B1 or B2) and a second carrier and/or carrier frequency or band different from the first (e.g. f2 or f1, and/or B2 or B1, respectively), in particular covering f1+f2 or B1+B2. A D2D device may comprise a D2D adaption module for adapting the receiver configuration as described in step 3.

Step 4 (optional): Receiving, in particular receiving simultaneously, using the adapted receiver configuration. This receiving may comprise receiving at least one of the first signals and/or receiving, e.g. signals, on the first carrier and/or carrier frequency and/or band (and/or f1), and receiving, at least one of the second signals and/or receiving, e.g. signals, on the second carrier and/or carrier frequency and/or band (and/or f2). It may be considered that this receiving (in particular receiving simultaneously) refers to using one receiver to receive on different carriers (e.g., carrier frequencies and/or bands) within a given timescale or time unit, e.g. subframe or frame (for example, subframe or frame according to LTE). The receiver may be adapted to switch, in particular within the given timescale or time unit, between such carriers according to its configuration and/or controlled by control circuitry of the D2D enabled node or UE, and/or to share the receiver and/or use of the receiver between different carrier frequencies. Alternatively or additionally, receiving simultaneously, in particular by one receiver using the adapted receiver configuration, may comprise receiving, in particular at the same time and/or in the same time resource (e.g. slot or subframe, for example in LTE), on both carriers and/or on f1 and f2 and/or on a frequency range or bandwidth covering and/or including at least f1 and f2.

According to a variant, the D2D enabled node or UE may indicate to another node (e.g., another D2D enabled node or UE or a network node) its ability to perform simultaneous receive operations on multiple carrier frequencies by configuring its receiver bandwidth over at least two carrier frequencies, wherein the ability may comprise
the D2D enabled node or UE's capability, or
the D2D enabled node or UE's current ability due to the D2D enabled node or UE's current configuration (with another configuration, the same D2D enabled node or UE may not have such ability). The configuration may comprise, e.g., D2D enabled node or UE RF and/or base band configuration which may be changed semi-statically or dynamically.

The ability indication may generally (and/or in all described variants or embodiments) comprise capability information, in particular regarding the capability to receive in one or more bandwidths covering at least two carriers and/or carrier frequencies and/or bands. The capability information may refer to a specific, in particular current and/or currently configured, configuration, or may refer to and/or indicate or identify a number of possible configurations of a receiver to receive on a bandwidth covering and/or including at least two carriers and/or carrier frequencies.

In one variant, the receiver is adapted for a receive operation and/or performs a receive operation. The receive operation may comprise receiving, on at least one first carrier frequency f1 in a D2D receive operation, and receiving, on at least one second carrier frequency f2 in a D2D receive operation or a cellular receive operation.

Alternatively or additionally, the relation between f1 and f2 may be any of the below,
f1 and f2 belong to the same frequency band,
f1 and f2 belong to the same frequency band which is an FDD band, and f1 is an UL carrier frequency and f2 is a DL carrier frequency,
f1 is UL carrier frequency, f2 is UL carrier frequency,
f1 is DL carrier frequency, f2 is DL carrier frequency,
f1 and f2 belong to different bands.

In particular, the receiver of the D2D enabled node or UE may be configurable and/or tunable to follow and/or provide at least one of such relations for at least on combination of f1, f2.

In yet another variant, the D2D enabled node or UE's ability and/or ability indication and/or capability information may also additionally depend and/or comprise and/or be based on, e.g., on any one or more conditions of:
one or more conditions regarding Receive operation types (e.g. D2D operation or cellular operation),
Environmental conditions (e.g., temperature, pressure),
Radio conditions (e.g., interference conditions, link quality, physical property of the propagation channel e.g. delay time spread or variation over time, maximum absolute difference in receive signal spectral density on f1 and f2 is below a threshold, . . . ),
Synchronization characteristics for f1 and f2, e.g.:
Frame or subframe misalignment of f1 and f2 at receiver is below a threshold,
Frame or subframe misalignment of f1 and f2 at transmitters is below a threshold,
Time synchronization error of the D2D enabled node or UE on f1 and/or f2 is below a threshold,
Absolute frequency synchronization accuracy for f1 and/or f2 is below a threshold,
Relative frequency synchronization accuracy for f1 and f2 is below a threshold,
Physical properties of each of the at least two carrier frequencies,
Supported maximum frequency of the multiple carrier frequencies is below a threshold:

max(f1, f2, . . . )<=f_max,
Supported minimum frequency of the multiple carrier frequencies is above a threshold:

min(f1, f2, . . . )>=f_min,
Maximum bandwidth of the multiple carrier frequencies is below a threshold:

max(f1_BW, f2_BW, . . . )<=BW_max,
Minimum bandwidth of the multiple carrier frequencies is above a threshold:

min(f1_BW, f2_BW, . . . )>=BW min.
Relative physical properties of the at least two carrier frequencies, e.g.,
Supported frequency distance df is below a threshold df_max:

abs(f1−f2)<=df_max,
supported frequency duplex distance d(f1,f2) is in a range [d_min,d_max]:

d_min<=d(f1,f2)<=d_max,

where d(f1,f2) is a duplex distance for f1 and f2, and where in one example 0=d_min<d_max, in another example 0<d_min<d_max=Inf, and in yet another example d_min=d_max. The duplex distance d(f1,f2) may also be, e.g., abs(f1_UL−f2_DL) or abs(f1_DL−f2_UL) in some examples. The frequency duplex distance may also be interchangeably called as duplex gap or frequency duplex gap.
Supported Rx-Rx separation Srxrx is in a range [Srxrx_min, Srxrx_max]: Srxrx_min<=Srxrx(f1,f2)<=Srxrx_max,

where Srxrx(f1,f2) is a Rx-Rx separation for f1 and f2, and where in one example 0=Srxrx_min<Srxrx_max, in another example 0<Srxrx_min<Srxrx_max=Inf, and in yet another example Srxrx_min=Srxrx_max. The Rx-Rx separation Srxrx(f1,f2) may also be, e.g., abs(f1_UL−f2_DL) or abs(f1_DL−f2_UL) in some examples. In other examples, only one of the Srxrx_min and Srxrx_max may be given. The Rx-Rx separation herein means that the D2D enabled node or UE receives D2D signals on f1 and D2D or cellular signals on f2 provided that the Srxrx(f1,f2) meets the above condition (i.e. Srxrx_min<=Srxrx(f1,f2)<=Srxrx_max). This may also be called as variable Rx-Rx separation capability or dynamic Rx-Rx separation capability of D2D enabled node or UE.
Supported Rx-Tx separation Srxtx is in a range [Srxtx_min, Srxtx_max]: Srxtx_min<=Srxtx(f1,f2)<=Srxtx_max,

where Srxtx(f1,f2) is a Rx-Tx separation for f1 and f2, and where in one example 0=Srxtx_min<Srxtx_max, in another example 0<Srxtx_min<Srxtx_max=Inf, and in yet another example Srxtx_min=Srxtx_max. The Rx-Tx separation Srxtx(f1,f2) may also be, e.g., abs(f1_UL−f2_DL) or abs(f1_DL−f2_UL) in some examples. In other examples, only one of the Srxtx_min and Srxtx_max may be given. The Rx-Tx separation herein may mean that the D2D enabled node or UE receives D2D signals on f1, transmits D2D or cellular signals on f1, and receives cellular signals on f2 provided that the Srxtx(f1,f2) meets the above condition (i.e. Srxtx_min<=Srxtx(f1,f2)<=Srxtx_max). This may also be called as variable Rx-Tx separation capability or dynamic Rx-Tx separation capability of D2D enabled node or UE. The Rx-Tx separation may also interchangeably called as Tx-Rx separation.
Total expanded maximum receive bandwidth over multiple carrier frequencies is below a threshold:

f1_BW+f2_BW<=BWtot_max.
Total expanded minimum receive bandwidth over multiple carrier frequencies is above a threshold:

f1_BW+f2_BW>=BWtot_min.

The conditions (e.g., the criteria and/or parameters in the conditions) may be pre-defined, pre-configured in the D2D enabled node or UE, or configured and signalled to the D2D enabled node or UE by another node (e.g., another D2D enabled node or UE or a network node). The D2D enabled node or UE and/or a D2D indicating module of a D2D device may be adapted to determine and/or for determining whether a condition is fulfilled and/or a parameter is set, in particular if it is relevant and/or basis for the ability indication.

In another variant, any one or any combination of the above conditions (e.g., criteria and/or thresholds) may comprise a separate D2D enabled node or UE's capability or ability to support particular RF scenarios. In yet another embodiment, this/these condition/s may be comprised in the D2D enabled node or UE's ability discussed herein and/or the ability may depend and/or be based upon such condition/s (i.e., the ability to perform simultaneous receive operations on multiple carrier frequencies by configuring its receiver bandwidth over at least two carrier frequencies).

The indicating of the D2D enabled node or UE's ability to at least one other node (e.g., another D2D enabled node or UE and/or network node) may be in one or more ways, e.g., any one or more of:
Implicit signalling,
Explicit signalling,
Following a certain pattern in the behaviour and/or in its transmissions; the pattern may be known to, and/or may be recognizable by, the other node, which may be adapted to associate the pattern with the D2D enabled node or UE's ability.

The indicating may be, e.g., upon a request or a message received from another node, upon a triggering condition or event, or autonomously decided by the D2D enabled node or UE.

The indication and/or capability information may additionally or alternatively comprise, e.g., any one or more of:
A binary indicator of the D2D enabled node or UE's ability,
A descriptive indicator of the D2D enabled node or UE's ability,
One or more conditions (e.g., see above) or their parameter values under which the D2D enabled node or UE's ability applies, e.g. supported Rx-Rx separation,
One or more carriers and/or frequencies and/or bands in which the D2D enabled node or UE's ability applies,
One or more carrier and/or frequency and/or band combinations in which the D2D enabled node or UE's ability applies (generally, the ability may be referring to the receiver being able to receive in a bandwidth covering and/or including the one or more carriers and/or frequencies and/or bands and/or combination or combinations),
One or more carrier frequencies in which the D2D enabled node or UE's ability applies,
One or more carrier frequency combinations in which the D2D enabled node or UE's ability applies,
Time-frequency resources in which the D2D enabled node or UE's ability applies (e.g., resources R1 and/or resources R2),
Receive operations types that can be performed on the multiple carrier frequencies,
Bandwidth characteristics (e.g., maximum receive bandwidth) of each of the multiple carrier frequencies,
Bandwidth characteristics of one or more combinations of carrier frequencies (e.g., maximum and/or minimum expanded receive bandwidth over f1 and f2).

A D2D device may comprise a corresponding D2D indicating module for indicating as described herein.

The D2D enabled node or UE may be adapted to determine, and/or determine the need to
Receive first signals for performing D2D receive operation on at least one first carrier frequency f1, and
Receive second signals for performing D2D receive operation and/or cellular receive operation on at least one second carrier frequency f2.

The need may be determined, e.g., based on one or more of:
upon receiving (from another node, higher layers, or an application) a configuration or an indication or a request or a trigger for performing one or more receive operations on f1 and/or f2,
upon determining the triggering event or condition triggering performing one or more receive operations on f1 and/or f2,
upon determining that at least one of the receive operations is on-going on f1 and/or f2,
upon determining the need to perform the receive operations over an expanded bandwidth in order to meet one or more pre-defined requirements for the receive operations on f1 and/or f2.

A D2D device may comprise a corresponding D2D need determining module for determining the need as described herein.

In one (optional) variant, the D2D enabled node or UE may be adapted to and/or perform determining and/or configuring resources for:
the receive operation on f1, which may include determining and/or configuring that the receive operation on f1 is performed in resources R1, and/or
the receive operation on f2, which may include determining and/or configuring that the receive operation on f2 is performed in resources R2.

The resources R1 and/or R2 may be pre-defined, pre-configured in the D2D enabled node or UE (e.g., stored in a memory accessible and/or included in control circuitry), configured by the D2D enabled node or UE autonomously, or configured in the D2D enabled node or UE by the network node by signalling the configuration to the D2D enabled node or UE. The resources R1 and/or R2 may be configured statically, semi-statically or dynamically.

In one example, the resources may be UL resources, DL resource, or resource for D2D operation.

Additionally or alternatively, the resources may be one or more time units (e.g., subframes). More additionally or alternatively, the resources may be comprised in UL resources further comprised in UL subframes indicated by a TDD UL/DL subframe configuration. More additionally or alternatively, the resources may be received in a D2D resource grant or in D2D control data and/or in allocation data. In yet another example, the resources may be comprised in a configuration indicative of resources for D2D enabled node or UE receive operation in half-duplex operation mode.

A D2D device may comprise a corresponding D2D resource determining module for determining and/or configuring resources as described herein

The D2D enabled node or UE may be adapted to adapt and/or adapts its receiver bandwidth (in particular, the bandwidth of its one receiver or one of its receivers) to simultaneously receive the first and the second signals on f1 and f2, respectively.

The adaptation may also be performed and/or the D2D enabled node or UE may be adapted to perform the adaptation such that one or more conditions (e.g., from those described above) are met. In another example, the adaptation may be performed and/or the D2D enabled node or UE may be adapted to perform the adaptation if one or more of the conditions are met and/or based on one or more of the conditions. The adaptation may also target meeting one or more pre-defined requirements by the D2D enabled node or UE for the first and/or the second operation.

In one example, the D2D enabled node or UE has been receiving signals on f1 or f2 only over bandwidth f1_BW or f2_BW, respectively, and it adapts the bandwidth to also receive signals on the other carrier frequency simultaneously (i.e., on f2 and f1, respectively) by expanding the receiver bandwidth to BWtot (BWtot>f1_BW or BWtot>f2_BW, respectively). In a further example, BWtot>f1_BW+f2_BW. In a further embodiment, the total receive bandwidth may be contiguous or clustered (i.e., one cluster on f1 and another cluster on f2). The D2D enabled node or UE may be adapted to perform such adaptation.

Generally, the D2D enabled node or UE may be adapted to expand the bandwidth its receiver (which may be the receiver to be adapted) is able to receive on from a bandwidth covering a first carrier and/or carrier frequency and/or band (e.g. f1 or f2), to a bandwidth covering the first carrier and/or carrier frequency and/or band and a second carrier and/or carrier frequency and/or band (f2 or f1, respectively), in particular to cover f1+f2. Expanding may be considered as adapting the receiver and/or the bandwidth.

In a further embodiment, the adapting or adaptation of the receiver configuration, in addition and/or alternatively to adapting receiver bandwidth, may comprise, e.g., any one or more of:
Adapting RF configuration of the D2D enabled node or UE (e.g., adapting variable Rx-Rx separation by selection the configuration for supporting the D2D enabled node or UE's operation over f1 and f2 with expanded bandwidth),
Adapting baseband configuration of the D2D enabled node or UE,
Adapting receiver sensitivity,
Adapting sampling rate (e.g., in frequency and/or in time),
Adapting time-frequency resource configuration on f1 and/or f2 for D2D enabled node or UE's operation (e.g., resources R1 and/or R2).

In the adaptation, also some additional information (which may be available in the D2D enabled node or UE, obtained from D2D enabled node or UE measurements, or received from another node) may be taken into account, e.g., any one or more of:
Time alignment at receiver of f1 and f2
Time alignment at transmitter of f1 and f2
Relation between R1 and R2
Rx signal difference between the first and the second signals
Conditions supported by the D2D enabled node or UE (e.g., as described herein)

A D2D device may comprise a corresponding D2D adaptation module for adapting as described herein.

According to a variant, the D2D enabled node or UE is adapted to receive, and/or receives, at least one first signal, and/or on a first carrier and/or carrier frequency and/or band and/or f1, and at least one second signal, and/or on a second carrier and/or carrier frequency and/or band and/or f1, simultaneously using the adapted receiver configuration. In particular, the D2D enabled node or UE may be adapted to receive, and/or receives, on f1 and f2.

In one embodiment, the D2D enabled node or UE may be adapted and/or required to meet, and/or is adapted to receive and/or receives based on, one or more pre-defined requirements for D2D and/or cellular operation, while performing the simultaneous receiving operations; the one or more conditions may be as outlined herein.

Additionally or alternatively, the D2D enabled node or UE may obtain, and/or be adapted to obtain, information about additional interference or interference information regarding interference due to the expanding the bandwidth, for example to facilitate the simultaneous receiving. Such information may, for example, comprise any one or any combination of:
interference from the resources which in frequency space are located between the resources comprised in f1_BW and resources comprised in f2_BW,
The inter-carrier interference or emissions from f1 to f2 and/or from f2 to f1.

Interference information may comprise parameters and/or parameter values and/or measurement values and/or estimated and/or calculated and/or pre-determined values.

The obtaining (of the interference information) may be and/or include any one or any combination of, e.g., performing measurements, pre-defined or pre-configured information and/or data and/or parameters and/or parameter values, which may be stored in a memory accessible to or included in control circuitry of the D2D enabled node or UE (e.g., known to the D2D enabled node or UE from its filter characteristics), and/or receiving the information from another node, for example bey receiving a corresponding transmission or indication (e.g., receiving a compensation factor from eNodeB), etc.

The D2D enabled node or UE may be adapted to mitigate the interference (e.g., any one or more of: cancelled, subtracted, compensated at the receiver) to improve the received signal quality of the first and/or the second signal, which may be performed based on the interference information.

A D2D device may comprise a corresponding D2D receiving module for receiving as described herein.

Alternatively or additionally, there are described steps or methods, in and/or performed by, a network node. The methods may comprise any one or any combination of the following steps. A network node may be adapted to carry out and/or perform any of the methods and/or any one or any combination of the steps. There may be envisioned a network device for performing any one or any combination of the steps or the methods, wherein the network device may comprise corresponding modules; a module may be for performing one or more than one of these steps:

Step N1: Obtaining an indication, which may be or comprise an ability indication and/or capability information, of at least one D2D enabled node or UE regarding the D2D enabled node or UE's ability to configure its receiver bandwidth to simultaneously receive signals over multiple carrier frequencies. A network node may comprise a NW obtaining module for obtaining according to step N1.

Step N2: Using the D2D enabled node or UE's ability indication for one or more operational tasks. A network device may comprise a NW use module for using the ability indication as described in step N2. Operational tasks may be tasks as described below.

The indication may be as described regarding the D2D enabled node or UE described herein.

The obtaining may be in and/or comprise, e.g., one or more ways of:
Receiving implicit or explicit indication from the D2D enabled node or UE, e.g. receiving a corresponding message or data or transmission,
Receiving implicit or explicit indication from another network node (e.g., from a neighbour eNodeB or MME or ProSe server), e.g. receiving a corresponding message or data or transmission,
Learning and recognizing D2D enabled node or UE's behaviour as well as associating the behaviour with the D2D enabled node or UE's ability indication, e.g., by sensing or performing measurements on signals from the D2D enabled node or UE and/or other D2D enabled node or UEs.

The obtained D2D enabled node or UE's ability indication may be used for any one or any combination of different purposes and/or operational tasks, which may comprise, e.g.:
Sending or forwarding the indication to another node,
Configuring D2D operation and/or cellular operation for a/the D2D enabled node or UE, e.g.,
configuring one or more carrier frequencies for D2D enabled node or UE operation,
measurement configuration,
resource allocation or scheduling for D2D and/or cellular operation,
measurement gap configuration.
Determining that D2D enabled node or UE supports certain RF scenarios described by conditions (e.g., D2D enabled node or UE supports variable Rx-Rx or Rx-Tx separations and corresponding values of Srxrx(f1,f2) and/or Srxtx(f1,f2) as described in section 5.3.1), and using this information (i.e. based on indicated D2D enabled node or UE capability information) for configuring the D2D enabled node or UE to operate for D2D and D2D or cellular operations on f1 and f2 respectively.
Configuring D2D enabled node or UE activity (e.g., DRX) to optimize power consumption in the D2D enabled node or UE,
Deciding on the need for handover, cell change or carrier frequency change,
Configuring multi-carrier operation of the D2D enabled node or UE,
Storing in a database or in history for later usage or for statistics.

Generally, the D2D enabled node or UE autonomously, or based on configuration done by the network node, may determine the need to simultaneously receive D2D signals and cellular signals on different carrier frequencies, and/or may adapt its receiver configuration for such simultaneous reception. The D2D enabled node or UE may be adapted to indicate and/or transmit to a network node, a one or more carriers and/or a set or range of carriers on which it can simultaneously receive D2D and cellular signals. This in turn may enable the network node to configure the appropriate carriers that the D2D enabled node or UE can use for simultaneous reception of D2D signals and cellular signals by adapting its receiver configuration. The D2D enabled node or UE may additionally or alternatively indicate its ability to another node (another D2D enabled node or UE or another network node) associated with the simultaneous receive operations over multiple carrier frequencies, and the corresponding information may be used by the node for one or more operational tasks.

There is also disclosed a D2D enabled node, which may be adapted to perform any one or any one combination of the methods and/or comprise any one or any one combination of the features described herein in the context of a D2D enabled node. In particular, control circuitry and/or a controller of the D2D enabled node may be adapted to control and/or perform the method and/or steps of the method. The D2D enable node may be a node of and/or for a wireless communication network.

There is also disclosed a network node, which may be adapted to perform any one or any one combination of the methods and/or comprise any one or any combination of the features described herein in the context of a network node. In particular, control circuitry and/or a controller of the network node may be adapted to control and/or perform the method and/or steps of the method. The network node may be a node of and/or for a wireless communication network.

There is also disclosed a method, in particular in and/or for D2D operation of a network, which may combine any of the steps of the methods for operating a D2D enabled node and a network node described herein.

There are also disclosed one or more software devices, e.g. a D2D device and/or a network device comprising suitable modules adapted to perform the steps of any of the methods described herein.

Generally, a D2D device may be for performing and/or implementing a method for and/or of and/or for a D2D enabled node or D2D enabled node or UE as disclosed herein and/or which the D2D enabled node or D2D enabled node or UE is adapted to perform and/or implement. The D2D device may comprise corresponding modules. A network device may be for performing and/or implementing a method for and/or of and/or for a network node as disclosed herein and/or which the network node is adapted to perform and/or implement. The network device may comprise corresponding modules.

There is also disclosed a computer program product comprising instructions executable by control circuitry and/or a computing device, the instruction causing the control circuitry and/or computing device to carry out and/or control any one of the methods described herein when executed by the control circuitry and/or computing device. The control circuitry and/or computing device may be implemented in any one or more than one of the nodes to carry out and/or control corresponding methods or method steps.

Modules performing method steps described herein may generally be implemented in software and/or hardware and/or firmware in and/or on corresponding nodes. Modules of or on or in one node or device, in particular modules for a D2D device or network device, may be implemented in a common module or flow and/or in parallel and/or independent modules or flows and/or share functionality.

A D2D enabled node may generally be a node adapted to perform D2D communication, in particular transmission and/or reception, and/or at least one type of D2D operations. In particular, a D2D enabled node may be a terminal and/or user equipment. The D2D enabled node may be adapted to transmit and/or receive D2D data based on allocation data, in particular on and/or utilizing resources indicate in the allocation data. D2D communication and/or transmission by a D2D enabled node may in some variants be in UL resources and/or at least one corresponding carrier or frequency and/or modulation.

In the context of this description, wireless communication may be communication, in particular transmission and/or reception of data, via electromagnetic waves and/or an air interface, in particular radio waves, e.g. in a wireless communication network and/or utilizing a radio access technology (RAT). The communication may be between nodes of a wireless communication network and/or in a wireless communication network. It may be envisioned that a node in or for communication, and/or in, of or for a wireless communication network is adapted for, and/or for communication utilizing, one or more RATs, in particular LTE/E-UTRA. A communication may generally involve transmitting and/or receiving messages, in particular in the form of packet data. A message or packet may comprise control and/or configuration data and/or payload data and/or represent and/or comprise a batch of physical layer transmissions. Control and/or configuration data may refer to data pertaining to the process of communication and/or nodes of the communication.

It may, e.g., include address data referring to a node of the communication and/or data pertaining to the transmission mode and/or spectral configuration and/or frequency and/or coding and/or timing and/or bandwidth as data pertaining to the process of communication or transmission, e.g. in a header. Each node involved in communication may comprise radio circuitry and/or control circuitry and/or antenna circuitry, which may be arranged to utilize and/or implement one or more than one radio access technologies. Radio circuitry of a node may generally be adapted for the transmission and/or reception of radio waves, and in particular may comprise a corresponding transmitter and/or receiver and/or transceiver, which may be connected or connectable to antenna circuitry and/or control circuitry.

Control circuitry of a node may comprise a controller and/or memory arranged to be accessible for the controller for read and/or write access. The controller may be arranged to control the communication and/or the radio circuitry and/or provide additional services. Circuitry of a node, in particular control circuitry, e.g. a controller, may be programmed to provide the functionality described herein. A corresponding program code may be stored in an associated memory and/or storage medium and/or be hardwired and/or provided as firmware and/or software and/or in hardware. A controller may generally comprise a processor and/or microprocessor and/or microcontroller and/or FPGA (Field-Programmable Gate Array) device and/or ASIC (Application Specific Integrated Circuit) device. More specifically, it may be considered that control circuitry comprises and/or may be connected or connectable to memory, which may be adapted to be accessible for reading and/or writing by the controller and/or control circuitry.

Pertaining to the term device-to-device (D2D), it should be noted that in some examples, the terms D2D′ or ‘proximity service’ (ProSe) or ‘peer-to-peer communication’ may be used interchangeably.

A D2D enabled node may be a UE, which may be D2D capable, and may be referred to as D2D enabled or capable UE. It may comprise any entity or device or node capable of at least receiving or transmitting radio signals on a direct radio link, i.e., between this entity and another D2D capable entity. A D2D-capable device or D2D enabled node may for example be comprised in or comprise a cellular UE, PDA, a wireless device, laptop, mobile, sensor, relay, D2D relay, a small base station employing a UE-like interface, etc. A D2D enabled node or UE is able to support at least one D2D operation. A D2D enabled node may generally be adapted for cellular operation and/or communication in a wireless communication network. A D2D enabled node may generally comprise radio circuitry and/or control circuitry for wireless communication, in particular D2D operation or communication and cellular operation or communication.

A D2D device may be a software/program arrangement arranged to be executable by a hardware device, e.g. control circuitry, and/or storable in a memory of e.g. a UE or terminal, which may provide D2D functionality and/or corresponding control functionality to e.g. a UE or terminal. A D2D enabled node or UE may comprise one receiver and/or more than one receivers adapted for D2D communication and/or cellular communication. The receiver/s may be seen as part of radio circuitry of the D2D enabled node or UE.

D2D operation may comprise any action or activity related to D2D or D2D communication and may be used interchangeably D2D communication. D2D operation may include, e.g., transmitting or receiving a signal/channel type or data for D2D purposes and/or in D2D operation, transmitting or receiving data by means of D2D communication, transmitting or receiving control or assistance data for D2D purpose, transmitting or receiving a request for control or assistance data for D2D, selecting a D2D operation mode, initiating/starting D2D operation, switching to D2D operation mode from a cellular operation mode, configuring receiver or transmitter with one or more parameters for D2D. D2D operation may be for a commercial purpose or to support public safety, using the data related to D2D. D2D operation may or may not be specific to a certain D2D service.

A D2D receive operation may be, and/or be comprised in, a D2D operation, which may, in one example, also involve other than D2D receive operations. A D2D operation may generally be performed or performable by a D2D enabled node or UE. A D2D receive operation may comprise receiving, by a D2D enabled node, of D2D data and/or signals. A D2D transmit operation may comprise, transmitting, by a D2D enabled node, of D2D data and/or signals. A D2D enabled node performing at least one D2D operation may be considered to be in D2D or D2D mode or in D2D operation.

Cellular operation (in particular by a D2D enabled node or UE) may comprise any action or activity related to a cellular network (any one or more RATs). Some examples of cellular operation may be a radio signal transmission, a radio signal reception, performing a radio measurement, performing a mobility operation or RRM related to a cellular network.

D2D transmission may be any transmission by a D2D enabled node or device and/or in a D2D operation or mode or communication. Some examples of D2D transmission may comprise physical signals or physical channels, dedicated or common/shared, e.g., reference signal, synchronization signal, discovery channel, control channel, data channel, broadcast channel, paging channel, scheduling assignment (SA) transmissions, etc. A D2D transmission on a direct radio link may be intended for receiving by another D2D device. A D2D transmission may be a unicast, groupcast, or broadcast transmission. A D2D transmission may be on the uplink time-frequency resources of a wireless communication system.

A coordinating or controlling or allocating node may be a node or network node that is adapted to schedule, decide and/or select and/or allocate, at least in part, time-frequency resources, in particular to one or more user equipments and/or D2D enabled nodes, to be used for at least one of: cellular transmissions and D2D transmissions. The coordinating node may also provide the scheduling information to another node such as another D2D enabled node, a cluster head, a radio network node such as eNodeB, or a network node (e.g. a core network node), MME, positioning node, D2D server, RNC, SON, etc). The network node or coordinating node may communicate with a radio network node. It may be envisioned that a coordinating node may also perform coordination for one or more D2D enabled node or UEs. The coordination may be performed in a centralized or distributed manner. A coordinating node may provide the functionality of an allocation node. A network device may be a software/program arrangement arranged to be executable by a hardware device, e.g. control circuitry, and/or storable in a memory of a network node, which may provide D2D functionality and/or corresponding control functionality to e.g. network node.

Pertaining to the radio spectrum, it may be noted that although at least some of the embodiments are described for D2D transmissions in the UL spectrum (FDD) or UL resources (TDD), the embodiments are not limited to the usage of UL radio resources, neither to licensed or unlicensed spectrum, or any specific spectrum at all.

A cellular network or wireless communication network may comprise e.g. an LTE network (FDD or TDD), UTRA network, CDMA network, WiMAX, GSM network, any network employing any one or more radio access technologies (RATs) for cellular operation. The description herein is given for LTE, but it is not limited to the LTE RAT.

RAT (radio access technology) may generally include: e.g. LTE FDD, LTE TDD, GSM, CDMA, WCDMA, WiFi, WLAN, WiMAX, etc.

A network node may be a radio network node (which may be adapted for wireless or radio communication, e.g. with a D2D enabled node or a UE) or another network node. A network node generally may be an allocation node or coordinating node. Some examples of the radio network node are a radio base station, eNodeB, a relay node, an access point, a cluster head, RNC, etc. The radio network node may be comprised in a wireless communication network and may also support cellular operation. A network node, in particular a radio network node, comprises radio circuitry and/or control circuitry, in particular for wireless communication. Some examples of a network node, which is not a radio network node, may comprise: a core network node, MME, a node controlling at least in part mobility of a wireless device, SON node, O&M node, positioning node, a server, an application server, a D2D server (which may be capable of some but not all D2D-related features), a node comprising a ProSe function, a ProSe server, an external node, or a node comprised in another network. Any network node may comprise control circuitry and/or a memory. A network node may be considered to be serving a D2D enabled node or UE, if it provides a cell of a cellular network to the served node or D2D enabled node or UE and/or is connected or connectable to the D2D enabled node or UE via and/or for transmission and/or reception and/or UL and/or DL data exchange or transmission and/or if the network node is adapted to provide the D2D enabled node or UE with allocation and/or configuration data and/or to configure the D2D enabled node or UE.

Multiple carrier frequencies or functionality may refer to any of: different carrier frequencies within the same frequency band or within different frequency bands, same PLMN or different PLMNs, same RAT or different RATs. D2D operation may or may not occur on dedicated carrier frequencies. DL and UL carrier frequencies in FDD are also examples of different carrier frequencies. A frequency band herein may be FDD, TDD, HD-FDD, or unidirectional (e.g., DL-only band such as Band 29, in some examples). Multiple carrier functionality may include carrier aggregation functionality.

The term ‘TPC for D2D’ used herein may refer to or comprise at least one power control command for one or more of D2D transmissions (e.g., SA, D2D data, D2D synchronization signal, D2D control channel, D2D discovery transmission, any D2D transmission for D2D communication, any D2D transmission for D2D discovery). ‘TPC for cellular UL’ may comprise or refer to at least one power control command sent by or via a network node or eNodeB to control tx power of one or more cellular UL transmissions. The two different types of TPCs may be sent in the same or separate messages to the D2D enabled node or UE, via the same or different channels or channel types (e.g., PDCCH and/or EPDCCH) and/or be comprises in one set or packet or message of allocation data or in different sets or packets or messages of allocation data.

A D2D enabled node may generally be a node adapted to perform D2D communication, in particular transmission and/or reception, and/or at least one type of D2D operations. In particular, a D2D enabled node may be a terminal and/or user equipment and/or D2D enabled machine and/or sensor. The D2D enabled node may be adapted to transmit and/or receive D2D data based on allocation data, in particular on and/or utilizing resources indicate in the allocation data. D2D communication and/or transmission by a D2D enabled node may generally be in UL resources and/or corresponding carrier or frequency and/or modulation. In this context, stopping D2D communication in response and/or based on a release message may be considered to correspond to transmitting based on allocation data, wherein the release message may be considered to be allocation data. A D2D enabled node (such as a UE) may be adapted for and/or capable of CA or CA operation. In particular, it may be adapted to transmit and/or receive one or more than one CCs and/or utilising, and/or participating in, carrier aggregation. A D2D enabled node may be adapted to configure itself according to configuration data, which may include setting up and/or scheduling resources and/or equipment for receiving and/or transmitting and/or sharing of resources and/or in particular D2D operation and/or cellular operation based on the configuration data. Configuration data may be received, by the D2D enabled node, from another node, in particular a network node.

A network node, in particular a controlling and/or allocating node, may generally be adapted to provide and/or determine and/or transmit configuration data, in particular to a D2D enabled node. Configuration data may be considered to be a form of allocation data and/or may be provided in the form of a message and/or data packet/s. Configuring a D2D enabled node or UE, e.g. configuring of the node by a network node, may include determining and/or transmitting configuration data to the node to be configured, i.e. the D2D enabled node or UE. Determining the configuration data and transmitting this data to a D2D enabled node or UE may be performed by different nodes, which may be arranged such that they may communicate and/or transport the configuration data between each other, in particular such that the node determining or adapted to determine the configuration data may transmit the configuration data to the node transmitting it or adapted to transmit it; the latter node may be adapted to receive the configuration data and/or relay and/or provide a message bases on the configuration data, e.g. by reformatting and/or amending and/or updating data received.

Transmit power (or power density) may generally refer to the power (or power density) of a signal transmitted or generally to the power of wireless transmission. Transmit power (or power density) may in particular refer to the power (or power density) of a signal transmitted by and/or transmissions of a D2D enabled node or UE. Transmit power generally may refer to a specific channel and/or frequency and/or cell and/or carrier and/or bandwidth and/or carrier aggregate and/or a general setup. UL transmit power, or shorter UL power, may refer to the power of a signal transmitted, in particular by a D2D enabled node or UE, in cellular operation and/or to or for a network node serving the D2D enabled node or UE, for example a base station or eNodeB. D2D transmit power (or power density) may refer to the power (or power density) of a signal transmitted, in particular by a D2D enabled node or UE, in D2D operation and/or for D2D transmission. Transmit power (or power density) may refer to or pertain to a time unit or interval, e.g. a slot, subframe or frame, and/or transmit power control may be performed for and/or updated in such units or intervals. Power control or transmit power control may generally refer to control of transmit power and/or transmit power spectral and/or temporal density. Power control commands in TPC format or TPC may be used for controlling power and/or to cause a D2D enabled node or UE receiving at least one such command or TPC message to control power based on and/or according to the command or TPC. The command or TPC may be transmitted to the D2D enabled node from or via a network node, in particular a base station or eNB or allocating node.

Capability data and/or a capability indication or indication message may provide and/or comprise capability information. In this context, the capability may refer to whether the D2D enabled node or UE is capable of operating simultaneously perform D2D and cellular operations on a combination of carriers and/or frequency bands and/or to which combination/s of carriers and/or frequency bands a D2D enabled node or UE can be configured, and/or is operable in and/or adapted to operate in, to simultaneously perform D2D and cellular operations; or at least a part of the corresponding combinations. Capabilities information and/or the indication or indication message, may indicate explicitly or implicitly one, or at least one, or a plurality of, combination/s of carriers and/or frequency bands on which the first D2D enabled node or UE can be configured and/or is operable in and/or adapted to operate in, to simultaneously perform D2D and cellular operations, and/or may comprise parameters and/or parameter values and/or indication and/or information regarding the capabilities of the first D2D enabled node. The capability indication or indication message may be transmitted or transmittable as a D2D transmission or a cellular transmission. It may be envisioned that a D2D enabled node or UE determines and/or transmits and/or is adapted to determine and/or transmit such a message either and/or both as a D2D transmission and as a cellular transmission. In particular, a D2D enabled node or UE may transmit or be adapted to transmit the indication or indication message as D2D transmission, in particular based on the target of the transmission being, and/or if the target of the transmission is, a second D2D enabled node or UE, and/or based on corresponding D2D resources being, and/or if corresponding D2D resources are, allocated to the D2D enabled node or UE.

Alternatively or additionally, the D2D enabled node or UE may transmit, and/or be adapted to transmit, the indication or indication message in or with a cellular transmission or operation, in particular if the target node is not a D2D enabled node and/or based on cellular or only cellular resources being allocated to the D2D enabled node or UE. A D2D enabled node may be adapted to obtain capabilities information, e.g. by reading it from a memory or storage, which may be a memory or storage of the D2D enabled node or UE. In one variant, which may be additionally or alternatively or independently, capability information may comprise information regarding the receiver and/or receiver ability or capability for (e.g., simultaneously) receiving on a first carrier and a second carrier, in particular on f1 and f2, and/or possible combinations of at least two carriers the receiver is able to receive on, in particular to receive on simultaneously. Capability information or ability indication may generally comprise information regarding bandwidths the receiver is able to receive in, in particular bandwidth covering and/or including at least a first carrier and a second carrier, e.g. f1 and f2, for given and/or certain and/or per-defined carriers f1 and f2, and/or a range of carriers f1 and f2. The carriers may generally be pre-defined, e.g. according to a standard like LTE.

Radio access technology may generally comprise, e.g., Bluetooth and/or Wifi and/or WIMAX and/or cdma2000 and/or GERAN and/or UTRAN and/or in particular E-Utran and/or LTE. A communication may in particular comprise a physical layer (PHY) transmission and/or reception, onto which logical channels and/or logical transmission and/or receptions may be imprinted or layered. A node of a wireless communication network may be implemented as a user equipment and/or base station and/or relay node and/or any device generally adapted for device-to-device communication.

A wireless communication network may comprise at least one of a device configured for device-to-device communication and/or a user equipment and/or base station and/or relay node, in particular at least one user equipment, which may be arranged for device-to-device communication with a second node of the wireless communication network, in particular with a second user equipment.

A node of or for a wireless communication network may generally be a wireless device configured for wireless device-to-device communication, in particular using the frequency spectrum of a cellular and/or wireless communications network, and/or frequency and/or time resources of such a network. Device-to-device communication may optionally include broadcast and/or multicast communication to a plurality of devices or nodes. A cellular network may comprise a network node, in particular a radio network node, which may be connected or connectable to a core network, e.g. a core network with an evolved network core, e.g. according to LTE. The connection between the network node and the core network/network core may be at least partly based on a cable/landline connection. Operation and/or communication and/or exchange of signals involving part of the core network, in particular layers above a base station or eNB, and/or via a predefined cell structure provided by a base station or eNB, may be considered to be of cellular nature or be called cellular operation. Operation and/or communication and/or exchange of signals without involvement of layers above a base station and/or without utilizing a predefined cell structure provided by a base station or eNB, may be considered to be D2D communication or operation, in particular, if it utilises the radio resources, in particular carriers and/or frequencies, and/or equipment (e.g. circuitry like radio circuitry and/or antenna circuitry, in particular transmitter and/or receiver and/or transceiver) provided and/or used for cellular operation.

A user equipment (D2D enabled node or UE) may generally be a device configured for wireless device-to-device communication and/or a terminal for a wireless and/or cellular network, in particular a mobile terminal, for example a mobile phone, smart phone, tablet, PDA, etc. A user equipment may be a node of or for a wireless communication network as described herein, in particular a D2D enabled node. It may be envisioned that a user equipment is adapted for one or more RATs, in particular LTE/E-UTRA. A user equipment may generally be proximity services (ProSe) enabled, which may mean it is D2D capable or enabled. It may be considered that a user equipment comprises radio circuitry and/control circuitry for wireless communication. Radio circuitry may comprise for example a receiver device and/or transmitter device and/or transceiver device. Control circuitry may include a controller, which may comprise a microprocessor and/or microcontroller and/or FPGA (Field-Programmable Gate Array) device and/or ASIC (Application Specific Integrated Circuit) device. It may be considered that control circuitry comprises or may be connected or connectable to memory, which may be adapted to be accessible for reading and/or writing by the controller and/or control circuitry. A node or device of or for a wireless communication network, in particular a node or device for device-to-device communication, may generally be a user equipment. It may be considered that a user equipment is configured to be a user equipment adapted for LTE/E-UTRAN.

A base station may be any kind of base station of a wireless and/or cellular network adapted to serve one or more user equipments. It may be considered that a base station is a node of a wireless communication network. A base station may be adapted to provide and/or define one or more cells of the network and/or to allocate frequency and/or time resources for communication to one or more nodes of a network, in particular UL resources, for example for device-to-device communication, which may be communication between devices different from the base station. Generally, any node adapted to provide such functionality may be considered a base station. It may be considered that a base station or more generally a network node, in particular a radio network node, comprises radio circuitry and/or control circuitry for wireless communication.

It may be envisioned that a base station or network node is adapted for one or more RATs, in particular LTE/E-UTRA. Radio circuitry may comprise for example a receiver device and/or transmitter device and/or transceiver device. Control circuitry may include a controller, which may comprise a microprocessor and/or microcontroller and/or FPGA (Field-Programmable Gate Array) device and/or ASIC (Application Specific Integrated Circuit) device. It may be considered that control circuitry comprises or may be connected or connectable to memory, which may be adapted to be accessible for reading and/or writing by the controller and/or control circuitry.

A base station may be arranged to be a node of a wireless communication network, in particular configured for and/or to enable and/or to facilitate and/or to participate in device-to-device communication, e.g. as a device directly involved or as an auxiliary and/or coordinating node. Generally, a base station may be arranged to communicate with a core network and/or to provide services and/or control to one or more user equipments and/or to relay and/or transport communications and/or data between one or more user equipments and a core network and/or another base station and/or be Proximity Service enabled. An eNodeB (eNB) may be envisioned as an example of a base station.

A base station may generally be proximity service enabled and/or to provide corresponding services. It may be considered that a base station is configured as or connected or connectable to an Evolved Packet Core (EPC) and/or to provide and/or connect to corresponding functionality. The functionality and/or multiple different functions of a base station may be distributed over one or more different devices and/or physical locations and/or nodes. A base station may be considered to be a node of a wireless communication network. Generally, a base station may be considered to be configured to be a coordinating node and/or to allocate resources in particular for device-to-device communication between two nodes of a wireless communication network, in particular two user equipments.

Device-to-device (D2D) communication or operation may generally refer to communication between nodes of a wireless communication network or corresponding operation of one or more nodes, which may utilize the frequency spectrum and/or frequency and/or time resources of the network, in particular according to LTE/E-UTRAN. The communication may be wireless communication. A device in this context may be a node of the wireless communication network, in particular a user equipment or a base station. Device-to-device communication may in particular be communication involving at least one user equipment, e.g. between two or more user equipments. Device-to-device communication may be relayed and/or provided via a base station or coordinating node or relay node, in particular without interaction with a core network and/or layers of the network above a base station or coordinating node, or be direct communication between two devices, e.g. user equipments, without involvement of a base station or coordinating node and/or with a base station or coordinating node providing merely auxiliary services, e.g. configuration data or a transmission configuration or related information for a message intended for device-to-device communication between user equipments. In the latter case, it may be considered that data and/or signals flowing between the nodes performing device-to-device communication are not transported via the base station and/or coordinating node. In contrast, during cellular communication, network layers above the eNB/base station/coordination node may generally be involved, in particular core layers which may be connected to the eNB/base station/coordinating node via cable/land line. During device-to-device communication, a message may be provided and/or transmitted and/or received.

A message may be considered to be or be represented by a batch of physical layer transmissions and/or may comprise such. A message may comprise information regarding the transmission configuration, in particular regarding related information, e.g. in a header, and/or a payload. A unidirectional message may be a message for connectionless communication and/or for which no prior communication and/or prior connection between the transmitting node and receiving node is necessary and/or available and/or for which no response or no response protocol or no handshake is expected. A device configured for and/or capable of device-to-device communication, which may be called D2D enabled device or node, may comprise control circuitry and/or radio circuitry configured to provide device-to-device communication, in particular configured to enable proximity services (ProSe-enabled), e.g., according to LTE/E-UTRA requirements. D2D operation or communication and cellular operation or communication may be considered different operation types or modes, which may generally performed using resources from the same pool of available resources, e.g. allocated resources and/or the same carriers.

A storage medium may be adapted to store data and/or store instructions executable by control circuitry and/or a computing device, the instruction causing the control circuitry and/or computing device to carry out and/or control any one of the methods described herein when executed by the control circuitry and/or computing device. A storage medium may generally be computer-readable, e.g. an optical disc and/or magnetic memory and/or a volatile or non-volatile memory and/or flash memory and/or RAM and/or ROM and/or EPROM and/or EEPROM and/or buffer memory and/or cache memory and/or a database.

Allocated resources may generally be frequency and/or time resources. Allocated resources may comprise frequency-related information, in particular regarding one or more carriers and/or bandwidth and/or subcarriers and/or time-related information, in particular regarding frames and/or slots and/or subframes, and/or regarding resource blocks and/or time/frequency hopping information. Allocated resources may in particular refer to UL resources, e.g. UL resources for a first D2D enabled node to transmit to and/or for a second D2D enabled node. Transmitting on allocated resources and/or utilizing allocated resources may comprise transmitting data on the resources allocated, e.g. on the frequency and/or subcarrier and/or carrier and/or timeslots or subframes indicated. It may generally be considered that allocated resources may be released and/or de-allocated. A network or a node of a network, e.g. an allocation node, may be adapted to determine and/or transmit corresponding allocation data indicating release or de-allocation of resources to one or more D2D enabled nodes, in particular to a first D2D enabled node. Accordingly, D2D resource allocation may be performed by the network and/or by a node, in particular a node within and/or within a cell of a cellular network covering the D2D enabled nodes participating or intending to participate in the D2D communication.

Allocation data may be considered to be data indicating and/or granting resources allocated by the allocation node, in particular data identifying or indicating which resources are reserved or allocated for D2D communication for a D2D enabled node and/or which resources a D2D enabled node may use for D2D communication and/or data indicating a resource grant or release. A grant or resource grant may be considered to be one example of allocation data. It may be considered that an allocation node is adapted to transmit allocation data directly to a node and/or indirectly, e.g. via a relay node and/or another node or base station. Allocation data may comprise control data and/or be part of or form a message, in particular according to a pre-defined format, for example a DCI format, which may be defined in a standard, e.g. LTE.

In particular, allocation data may comprise information and/or instructions to reserve resources or to release resources, which may already be allocated. Generally, allocation data may indicate and/or instruct transmission mode and/or configuration, in particular regarding a power level of transmission, e.g. for the first D2D enabled node. The first D2D enabled node may generally be adapted to perform transmission configuration according to allocation data, in particular to set a corresponding power level. It may be considered that allocation data comprises and/or is implemented as TPC and/or in TPC format.

A D2D transmission may be considered to be of a different type than a cellular and/or UL transmission. A transmission may pertain to a specific frequency and/or spectrum and/or bandwidth and/or carrier.

A receiver or receiver chain may generally be provided by a transceiver arrangement, which may have transmitting capabilities included, or as a separate arrangement, which may be implemented without having transmitting capacities included.

A measurement gap may refer to a time gap or interval, in which no transmission and reception happens, in particular regarding a serving cell or a given carrier. Since there is no signal transmission and reception during the gap (at least in the serving cell or given carrier), a D2D enabled node or UE can switch to another or a target cell or carrier and/or perform a measurement on the target cell or carrier, e.g. for signal quality, utilizing the same receiver.

The term “intra-frequency” may refer to issued related to the same frequency/bandwidth and/or carrier, e.g. between neighboring cells (which may be provided by different BSs) having the same frequencies available. The term “inter-frequency” may refer to issues related to different frequencies/bandwidths and/or carriers, e.g. between different carriers in a multi-carrier arrangement.

A receiving operation may comprise a measurement operation, e.g. a signal quality measurement, which may be performed in a measurement gap, in which a receiver switching to a carrier/frequency to be measured may be performed.

Some useful abbreviations comprise:

3GPP 3^{rd} Generation Partnership Project

Ack/Nack Acknowledgment/Non-Acknowledgement, also A/N

AP Access point

B1, B2, . . . Bn Bandwidth of signals, in particular carrier bandwidth Bn assigned to corresponding carrier or frequency f1, f2, fn

BER/BLER Bit Error Rate, BLock Error Rate;

BS Base Station

CA Carrier Aggregation

CoMP Coordinated Multiple Point Transmission and Reception

CQI Channel Quality Information

CRS Cell-specific Reference Signal

CSI Channel State Information

CSI-RS CSI reference signal

D2D Device-to-device

DL Downlink

EPDCCH Enhanced Physical DL Control CHannel

DL Downlink; generally referring to transmission of data to a node/into a direction further away from network core (physically and/or logically); in particular from a base station or eNodeB to a D2D enabled node or UE; often uses specified spectrum/bandwidth different from UL (e.g. LTE)

eNB evolved NodeB; a form of base station, also called eNodeB

E-UTRA/N Evolved UMTS Terrestrial Radio Access/Network, an example of a RAT

f1, f2, f3, . . . , fn carriers/carrier frequencies; different numbers may indicate that the referenced carriers/frequencies are different

f1_UL, . . . , fn_UL Carrier for Uplink/in Uplink frequency or band

f1_DL, . . . , fn_DL Carrier for Downlink/in Downlink frequency or band

FDD Frequency Division Duplexing

ID Identity

L1 Layer 1

L2 Layer 2

LTE Long Term Evolution, a telecommunications standard

MAC Medium Access Control

MBSFN Multiple Broadcast Single Frequency Network

MDT Minimisation of Drive Test

NW Network

OFDM Orthogonal Frequency Division Multiplexing

O&M Operational and Maintenance

OSS Operational Support Systems

PC Power Control

PDCCH Physical DL Control CHannel

PH Power Headroom

PHR Power Headroom Report

PSS Primary Synchronization Signal

PUSCH Physical Uplink Shared CHannel

R1, R2, . . . , Rn Resources, in particular time-frequency resources, in particular assigned to corresponding carrier f1, f2, . . . , fn

RA Random Access

RACH Random Access CHannel

RAT Radio Access Technology

RE Resource Element

RB Resource Block

RRH Remote radio head

RRM Radio Resource Management

RRU Remote radio unit

RSRQ Reference signal received quality

RSRP Reference signal received power

RSSI Received signal strength indicator

RX reception/receiver, reception-related

SA Scheduling Assignment

SINR/SNR Signal-to-Noise-and-Interference Ratio; Signal-to-Noise Ratio

SFN Single Frequency Network

SON Self Organizing Network

SSS Secondary Synchronization Signal

TPC Transmit Power Control

TX transmission/transmitter, transmission-related

TDD Time Division Duplexing

UE User Equipment

UL Uplink; generally referring to transmission of data to a node/into a direction closer to a network core (physically and/or logically); in particular from a D2D enabled node or UE to a base station or eNodeB; in the context of D2D, it may refer to the spectrum/bandwidth utilized for transmitting in D2D, which may be the same and/or correspond and/or be a subset of to the one used for UL communication to a eNB in cellular communication; in some D2D variants, transmission by all devices involved in D2D communication may be in UL spectrum/bandwidth/carrier/frequency

These and other abbreviations may be used according to LTE standard definitions.

In this description, for purposes of explanation and not limitation, specific details are set forth (such as particular network functions, processes and signaling steps) in order to provide a thorough understanding of the technique presented herein. It will be apparent to one skilled in the art that the present concepts and aspects may be practiced in other embodiments and variants that depart from these specific details.

For example, the concepts and variants are partially described in the context of Long Term Evolution (LTE) or LTE-Advanced (LTE-A) mobile or wireless communications technologies; however, this does not rule out the use of the present concepts and aspects in connection with additional or alternative mobile communication technologies such as the Global System for Mobile Communications (GSM). While the following embodiments will partially be described with respect to certain Technical Specifications (TSs) of the Third Generation Partnership Project (3GPP), it will be appreciated that the present concepts and aspects could also be realized in connection with different Performance Management (PM) specifications.

Moreover, those skilled in the art will appreciate that the services, functions and steps explained herein may be implemented using software functioning in conjunction with a programmed microprocessor, or using an Application Specific Integrated Circuit (ASIC), a Digital Signal Processor (DSP), a Field Programmable Gate Array (FPGA) or general purpose computer. It will also be appreciated that while the embodiments described herein are elucidated in the context of methods and devices, the concepts and aspects presented herein may also be embodied in a program product as well as in a system comprising control circuitry, e.g. a computer processor and a memory coupled to the processor, wherein the memory is encoded with one or more programs or program products that execute the services, functions and steps disclosed herein.

It is believed that the advantages of the aspects and variants presented herein will be fully understood from the foregoing description, and it will be apparent that various changes may be made in the form, constructions and arrangement of the exemplary aspects thereof without departing from the scope of the concepts and aspects described herein or without sacrificing all of its advantageous effects. Because the aspects presented herein can be varied in many ways, it will be recognized that any scope of protection should be defined by the scope of the claims, in particular in the light of the description and drawings.

1-8. (canceled)

9. A device-to-device (D2D)-enabled node for a wireless communication network, the D2D-enabled node comprising a receiver, the D2D-enabled node further being configured to adapt a receiver configuration to receive signals simultaneously on a first carrier frequency f1 and a second carrier frequency f2.

10. The D2D-enabled node of claim 9, wherein the receiver is configured to receive on at least the first carrier frequency f1, in a D2D receive operation, and receive on at least the second carrier frequency f2, in a D2D receive operation or a cellular receive operation.

11. A method performed by a D2D-enabled node, the D2D-enabled node comprising a receiver, the method comprising:
adapting a receiver configuration to receive signals simultaneously on a first carrier frequency f1 and a second carrier frequency f2.

12. The method of claim 11, further comprising receiving on at least the first carrier frequency f1, in a D2D receive operation, and receiving on at least the second carrier frequency f2, in a D2D receive operation or a cellular receive operation.

13. A network node for a wireless communication network, wherein the network node is configured to:
obtain an indication of at least one D2D-enabled node regarding the D2D-enabled node's ability to configure its receiver bandwidth to simultaneously receive signals over multiple carrier frequencies; and
use the indication for one or more operational tasks.

14. A method performed by a network node, the method comprising:
obtaining an indication of at least one D2D-enabled node regarding the D2D-enabled node's ability to configure its receiver bandwidth to simultaneously receive signals over multiple carrier frequencies; and
using the indication for one or more operational tasks.

15. A non-transitory computer-readable medium comprising, stored thereupon, a computer program product comprising instructions executable by control circuitry of a D2D-enabled node, the instructions causing the control circuitry to carry out the method of claim 11 when executed by the control circuitry.
